(19) United States
(12) Patent Application Publication
(10) Pub. No.: US 2026/0307469 A1
(43) Pub. Date: Oct. 8, 2026

(54) Rear Support for a Side-To-Side Cover System

(71) Applicant: Aero Industries, Inc., Indianapolis, IN (US)

(72) Inventor: Ronald L. Eggers, Fremont, NE (US)

(21) Appl. No.: 19/634,325

(22) Filed: Mar. 31, 2026

Related U.S. Application Data
(60) Provisional application No. 63/783,002, filed on Apr. 3, 2025.

(51) Int. Cl. B60J 7/08

(52) U.S. Cl. CPC B60J 7/085

(57) ABSTRACT

A cover system for an open-topped container body includes a cover assembly supported by a first arm assembly pivotably mounted at one end of the container body and a second arm assembly mounted at the opposite end of the body. The first arm assembly is coupled to one end of the cover assembly and includes a drive motor for rotating the cover assembly between deployed and retracted positions. The second arm assembly includes a lower arm pivotably mounted to the container body, an extension arm pivotably connected to the lower arm, and an engagement element including a chain for connecting the end of the extension arm to the roller. The second arm assembly is configured so that the end of the extension arm is always adjacent the roller and the chain has a relatively short length.

### PRIORITY CLAIM

This application claims priority to U.S. Provisional No. 63/783,002, filed on Apr. 10, 2025, the entire disclosure of which is incorporated herein by reference.

### BACKGROUND

The present disclosure relates to cover systems for open-topped containers, such as dump bodies, refuse haulers, grain trailers and the like. These cover systems utilize flexible covers, such as tarpaulins, that are pulled across the open top of the container body. The flexible cover is wound onto a roller as the cover is moved to its open or stowed position and unwound from the roller as the cover is moved to a closed position covering the container body. An arm assembly supports the opposite ends of the flexible to control the movement of the cover to and from its end positions.

An exemplary side-to-side system is depicted in FIG. 1. The Vehicle V includes a tractor T and a trailer body B, which may be a dump body, grain hauler and the like. A tarping system 10 is mounted to the trailer with a cover or tarpaulin 11 sized to extend the entire length of the open top O of the trailer body, and to span the width of the open top when the tarping system is in its closed configuration. A drive mechanism 12 is engaged to a roller R supporting the cover 11 that is configured to move the cover from one side of the trailer body B to the other. A support mechanism 13 is engaged to the opposite end of the cover roller to support the cover as it is deployed or retracted. In a typical side-to-side cover system, the drive mechanism 12 rotates the roller R and cover so that the cover travels over the end caps C of the trailer body. It should be appreciated that the locations of the drive mechanism 12 and support mechanism 13 can be switched between the opposite ends of the railer body B.

In one example, the drive mechanism 12 can include a pivoting arm assembly 100 as shown in FIGS. 2-3, which can be similar to the assembly disclosed in U.S. Pat. No. 10,023,033 which issued on Jul. 17, 2018 (the '033 Patent), of which the entire disclosure is incorporated by reference, or similar to the AeroForce® STS sold by Aero Industries, Inc. The arm assembly 100 includes a base 102, an arm 104 pivotably mounted on the base and an extension arm 108 that is pivotably mounted to the arm 104 by a pivot joint 106. A motor assembly 109 is mounted on the distal end of the extension arm 108. The output shaft 109a of the motor assembly 109 is connected to or integrated into the axle A of the roller R on which the cover 11 is wound and unwound. The arm assembly 100 includes a cable 110 that is anchored at the base and extends along the length of the lower arm 104 to the pivot joint 106, and a cable 112 that is anchored at the pivot joint 106 and extends along the length of the extension arm. A compression spring 111 is concentrically disposed around the cable 110 in the lower arm 104 and a second spring 113 is concentrically disposed around the cable 112 in the extension arm, as particularly shown in FIG. 3. The cable 110 is fixed to an end cap 111a at the end of the compression spring 111, and is connected to a pulley 114, mounted on the base 102. As the lower arm 104 pivots relative to the base the cable winds around the pulley and pulls the end cap 111a toward the pulley to compress the spring. The cable 112 is fixed to an end cap 113a of the spring 113 and is connected to a pulley 115, mounted on the pivot joint 106. As the extension arm 108 pivots relative to the lower arm the cable 112 winds around the pulley 115 and pulls the end cap 113a toward the pulley to compress the spring. This movement compresses the two springs 111, 113 to provide a counter-torque that increases as the cable winds around the pulley. Other details of the pivoting arm assembly 100 can be obtained from the '033 Patent.

In operation, the motor assembly winds the cover onto the roller R against the torque generated by the cables 110, 112 and springs 111, 113 as the cover is moved to its retracted position. The cover is unwound by action of the compression springs 111, 113 on the arm 104 as the motor assembly is driven in reverse to move the cover to its deployed position covering the container opening. The extension arm 108 pivots about the pivot joint 106 as the cover is extended across to the opposite side S of the opening O so that the axle can be engaged by a locking mechanism to hold the cover taut across the opening. In the case of heaped loads within the container body B, the end caps C (FIG. 1) can be curved so that the axle A rides along the end caps to raise and lower the axle as it is deployed or retracted. The cable and spring system of the arm assembly 100 holds the axle against the curved end caps as the axle traverses the curved edges.

As noted above, the drive mechanism 12 is disposed at one end of the container body B, namely the rear end in the example shown in FIG. 1. The opposite end of the axle A of the tarp roller R is supported by the support mechanism 13. One example of a prior support mechanism is the multiflex pivoting arm assembly 150 shown in FIG. 4. The pivoting arm assembly 150 does not include a drive motor, as with the drive mechanism 12 and arm assembly of FIGS. 2-3. As disclosed in U.S. Pat. No. 10,155,435, which issued on Dec. 18, 2018 (the '435 Patent), of which the entire disclosure is incorporated herein by reference, the multiflex pivoting arm assembly 150 includes a base 152 and a lower arm 153 pivotably mounted on the base, similar to the arm 104 of the drive mechanism 12. The multiflex pivoting arm assembly 150 is configured to generate some torque to assist movement of the assembly 150 as the cover is deployed by the drive mechanism 12. Thus, a cable 160 and a compression spring 161 are provided that operate in the same manner as the cable and spring 110, 111 of the arm assembly 100, to provide a counter-torque as the cover is wound to its retracted position, and to provide an assisting torque to help pivot the lower arm as the arm moves to the deployed position covering the container opening O.

The multiflex pivoting arm assembly 150 includes a flexible link 165 that is pivotably fastened to a mounting cap 154 at the free end of the arm 153 The flexible link 165 can be a chain encased in an outer sheath 169. The chain may be a standard chain with multiple links extending along the length of the flexible link 165. The flexible link or chain 165 is fixed at one end to the mounting cap 154 and includes an engagement element 166 at its opposite end configured to be coupled to the axle A of the cover assembly. The engagement element 166 can include an elbow joint 167 at the opposite end of the flexible link that forms a right angle joint between the flexible link 165 and a bushing assembly 168 that is configured to be fixed within the roller of the cover. Alternatively, the bushing assembly 168 can be configure to engage the axle A of the cover assembly. Other details of the multiflex pivoting arm assembly can be found in the '435 Patent.

The multiflex pivoting arm assembly 150 is mounted to the end wall E of the trailer body B at the end of the trailer opposite the drive mechanism 12 or arm assembly 100. As the drive assembly rotates the roller of the cover, the cover advances across the end caps of the trailer body. The roller is connected to the bushing assembly 168 so that movement of the roller R and cover 11 across the trailer body draws the flexible link 165 with it, thereby pivoting the rear pivoting arm assembly 150. The rear pivoting arm assembly is generally passive in that it does not generate a rotational torque to the forward end of the cover roller. However, the addition of the spring and cable to the rear pivot system provides enough tension to the flexible link 165 to keep the link taut during operation, and thereby help maintain uniform movement of the roller and cover.

While the multiflex pivoting arm assembly 150 is sufficient to support the free end of the roller R opposite the motor-driven arm assembly 100, it can be problematic for certain heaped loads. In particular, as the arm assembly 150 moves to its fully deployed position across the container opening O, the chain 165 and elbow joint 167 must pull the axle A of the roller over the side edge S (FIG. 2) of the container body B, and eventually into engagement with a locking feature, such as a bracket into which the axle is drawn at the end of the deployment cycle. Since the chain 165 is essentially pulling the roller axle A downward, the roller and cover have a tendency to scrape across the heaped load adjacent the side edge S. Some heaped loads are heavy and dense enough to avoid being dislodged by the roller and cover. However, other heaped loads, such as feathers in rendering waste, are easily dislodged and scraped out of the container body B as the roller and cover traverse the side edge S.

Consequently, there is a need for a rear support assembly that can support the end of the roller opposite the end with the drive mechanism and that can accommodate heaped loads in a container.

### SUMMARY OF THE DISCLOSURE

A cover system for an elongated open-topped container body comprises an elongated cover sized and configured to span a length of the open top of the container and to span the width of the open top of the container in a deployed position, in which the cover is wound onto and unwound from a cylindrical roller spanning the length of the container. A first arm assembly is pivotably mountable at one end of the container body, and is configured to be coupled to one end of the cylindrical roller. The first arm assembly includes a drive motor for rotating the roller to wind the cover onto the roller to a retracted position in which the open top is open and to unwind the cover from the roller in a deployed position in which the cover spans the width of the open top.

The cover system includes a second arm assembly mountable at an opposite end of the container body that includes an elongated lower arm pivotably mountable at one end thereof to the container body and an elongated extension arm, pivotably mounted at a first end to an end of the lower arm opposite the one end and having an opposite second end. The lower arm and the extension arm are sized so that said opposite second end of the extension arm is immediately adjacent the cylindrical roller at all times when the roller moves between the retracted and deployed positions. An engagement assembly connects the opposite second end of the extension arm to the roller of the cover. In one feature, the engagement assembly includes an elongated flexible link, fastened at a first end thereof to the opposite second end of the extension arm and connectable at an opposite second end to the roller. The flexible link can be a chain having a length that is relatively shorter than either of the two arm assemblies so that the roller is always maintained in close proximity to the end of the extension arm and so that the flexible link is always maintained in tension as the cover is moved between the retracted and deployed positions.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a side view of an exemplary side-to-side cover system for the open top of a trailer body.

FIG. 2 is a perspective view of a drive mechanism for the side-to-side cover system shown in FIG. 1.

FIG. 3 is a perspective cut-away view of the arm assembly shown in FIG. 2.

FIG. 4 is a perspective view of a rear support assembly for the cover system shown in FIG. 1.

FIG. 5 is a perspective view of a rear support assembly according to the present disclosure for use with the side-to-side cover system shown in FIG. 1, shown with the rear support assembly in two positions on the trailer body.

FIG. 6 is a side view of the rear support assembly of FIG. 5.

FIG. 7 is a perspective view of the rear support assembly shown in FIG. 6.

FIG. 8 is a view of the distal end of the rear support assembly shown in FIG. 6, with the engagement assembly removed from the distal end.

FIG. 9 is an exploded view of the engagement assembly shown in FIG. 8.

FIGS. 10A-10D are perspective views of the rear pivoting arm assembly according to the present disclosure, shown in different stages of movement from the stowed to the deployed configuration of the cover.

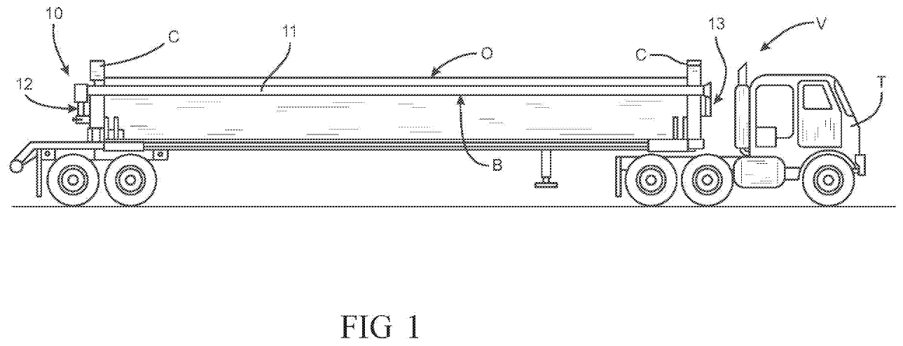

### DETAILED DESCRIPTION

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

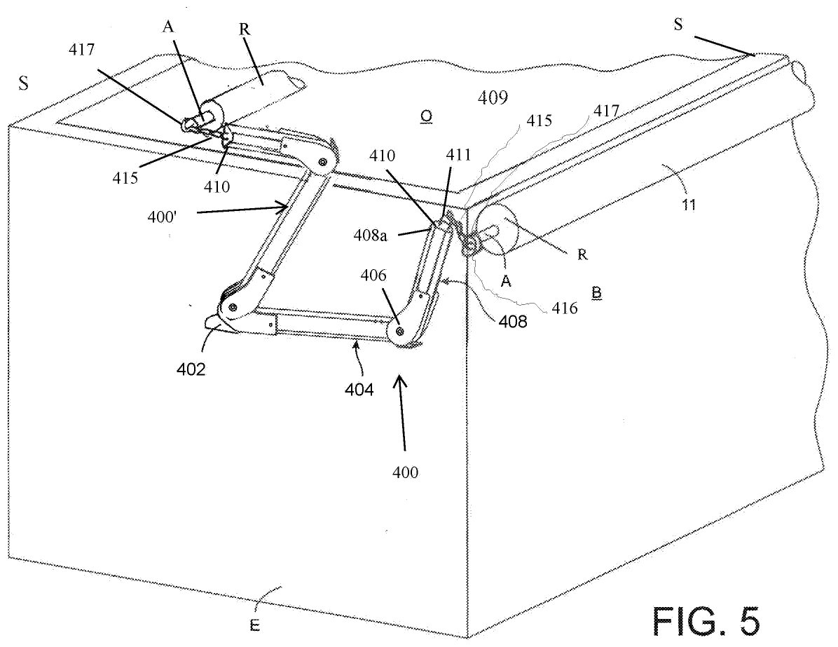

In accordance with the present disclosure, a rear support assembly 400 is provided, as shown in FIG. 5, that can better handle heaped loads, particularly in a side-dump trailer. The rear support assembly 400 includes a base 402, a lower arm 404 pivotably mounted on the base, pivot joint 406 and extension arm 408 that is pivotably connected to the lower arm by the pivot joint. These components of rear support assembly have essentially the same construction as the base 102, lower arm 104, pivot joint 106 and extension arm 108 of the motor-driven arm assembly 100. Thus, the rear support assembly 400 includes a cable and spring arrangement similar to the cables 110, 112 and the springs 111, 113 of the arm assembly 100. It can be appreciated that, as in the assembly 100, the cable 110 is engaged to a pulley 403 similar to the pulley 114, anchored at the base 402, and extends along the length of the lower arm 404. The cable 112 is engaged to a pulley 407, similar to the pulley 115, anchored at the pivot joint 106 and extends along the length of the extension arm 408. Furthermore, the lower arm 404 includes the concentric spring 111, and the extension arm includes the concentric spring 113. However, since the rear support assembly 400 does not provide a driving force to roll and unroll the cover on the roller R, the springs extending through the two arms 404, 408 of the rear support assembly 400 do not need to have the same spring constant as the comparable springs for the motor-driven arm assembly 100.

It can be appreciated that the cable and spring arrangements described above generate torque in the lower arm and the extension arm. Alternatively, the lower arm can include a torsion spring between the base and the lower arm in lieu of the cable 110 and spring 111. Likewise, the extension arm can include a torsion spring at the pivot joint in lieu of the cable 112 and spring 113.

It is noted that the springs 111, 113 are in a non-compressed or minimally compressed state when the rear support assembly is in its extended or deployed position shown in FIG. 5. The length of the extension arm 408 is sufficient to position the distal end 408a of the arm adjacent the axle A of the cover roller R when the rear support assembly 400 is in its retracted and deployed positions. When the support assembly is in its retracted position, the extension arm 408 extends downward from the lower arm 404, whereas the extension arm extends upward in the deployed position.

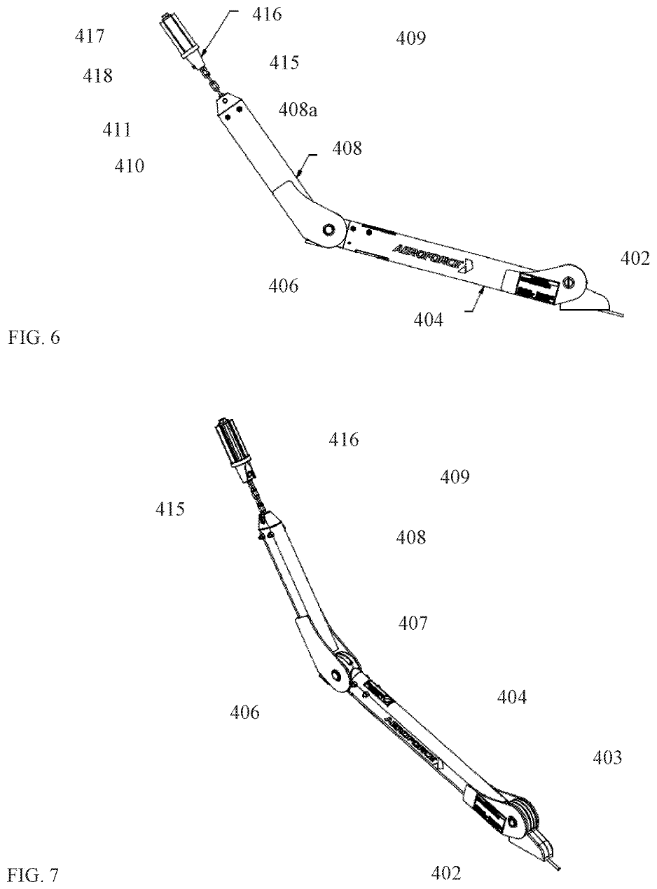

The rear support assembly 400 includes an engagement assembly 409 between the extension arm 408 and the axle A of the roller R that allows the roller to rotate on its axis to wind and unwind the cover, while also supporting the roller and cover as they are driven by the motor-driven arm assembly 100 across the top of the container. The distal end 408a of the extension arm 408 terminates in a first cap 410 on which is mounted a hasp or a mounting bolt 411, as best shown in FIGS. 6-9. A flexible link 415 is connected at one end to the hasp/mounting bolt 411 and at its opposite end to a mounting feature 416 that is affixed to the axle A of the cover roller R. The mounting feature 416 can be in the form of a second cap 417 that is fastened to the end of the axle, and can include a hasp/mounting bolt 418 for attachment to an end link of the flexible link 415. In one specific embodiment, the flexible link 415 is a conventional chain, with its end links connected to the mounting bolt 411 and to the mounting feature 416. Since the distal end 408a of the extension arm is adjacent the roller R, or particularly the axle A of the roller, the length of the flexible link is short relative to the arms 404, 408. In particular, the flexible link 415 has a length of 9 inches or less, and preferably 6 inches or less.

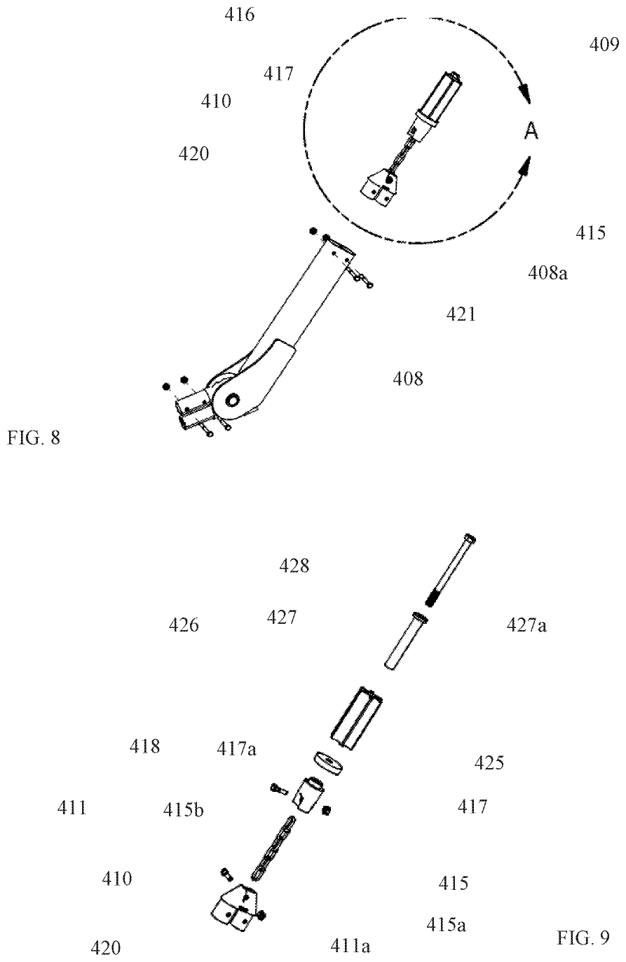

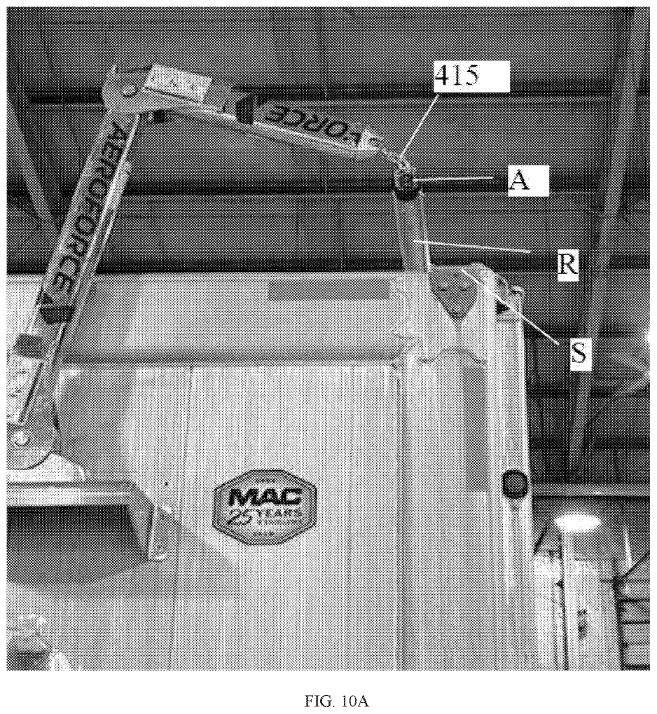

As shown in the detail views of FIGS. 8-9, the first cap 410 includes a stem structure 420 that is configured for a snug fit into a complementary-configured bore in the end 408a of the extruded body of the extension arm 408. Bolts 421 can be provided to fix the stem structure 420 within the arm 408. The mounting bolt 411 can engage a bore 411a in the first cap 410 to trap the end link 415a of the chain 415 in the cap 410. The opposite end link 415b of the chain 415 is trapped in the second cap 417 by a mounting bolt 418 in a similar manner. It is contemplated that when the flexible link 415 is not a chain the link can include fittings at the end of the link that can receive the corresponding mounting bolts 411, 418. It is further contemplated that one or both of the bolts 411, 418 can be replaced with a hasp that is received within the end links 415a, 415b.

The second cap 417 receives a washer 425 which provides a bearing surface for a cylindrical clamping hub 426. The hub 426 is configured to be press-fit in the hollow end of the axle A of the roller R of the cover system. A bolt 428 and concentric cylindrical bushing 427 pass through the hub 426 and at least the bolt passes through the washer 425 for threaded engagement with a threaded bore 417a in the cap. The clamping hub 426 is thus trapped between a cylindrical flange 427a of the cylindrical bushing 427 and the washer 425 so that the clamping hub 426 can rotate with the axle A and roller R relative to the second cap 417 and rear support assembly 400.

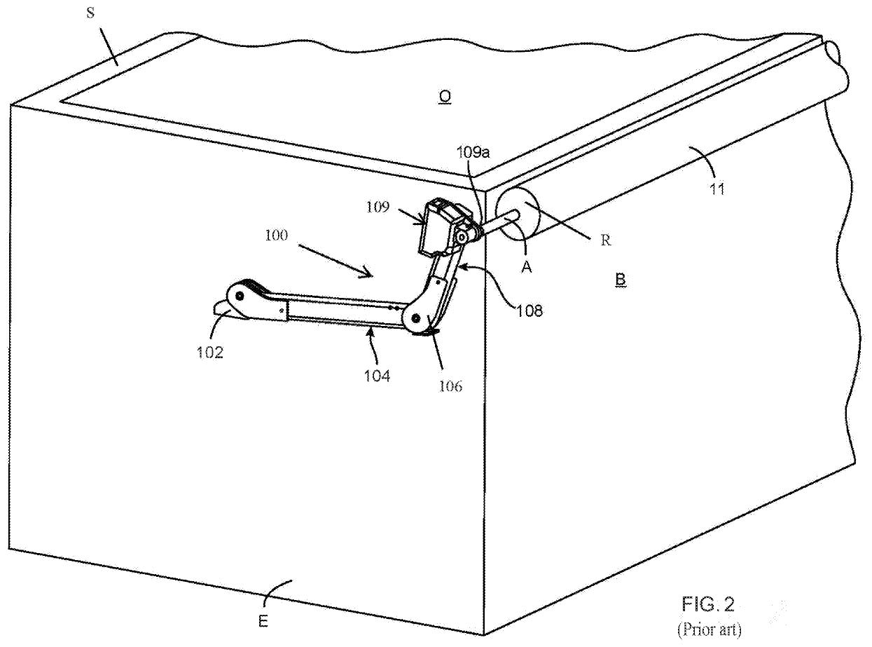

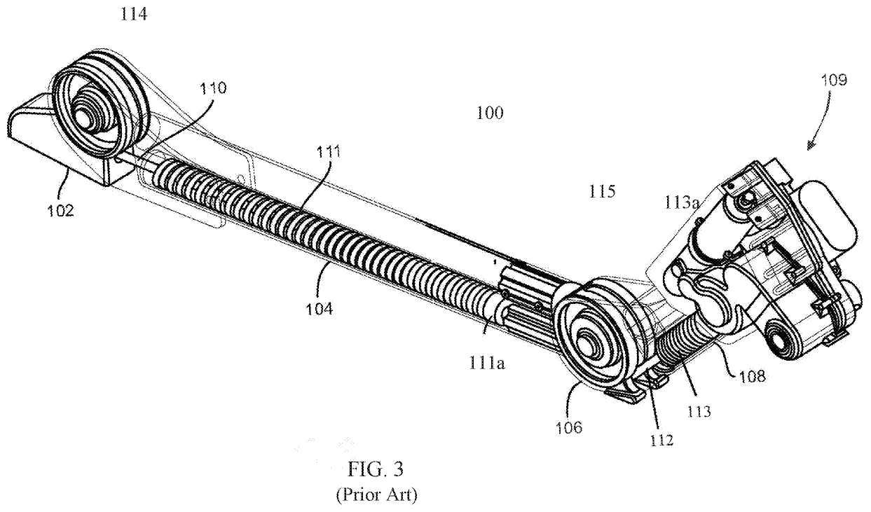

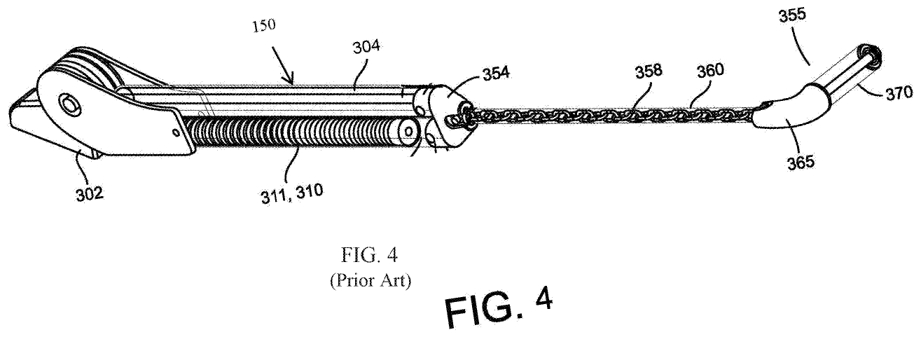

The rear support assembly 400 is shown in its deployed position in FIG. 5, in which the cover would be fully deployed over the opening O. The arm assembly 100 (FIG. 2) starts its deployment from the opposite side S of the container body. As the motor-driven arm assembly 100 unwinds the cover from the roller R, the arm assembly 100 and the rear support assembly 400 pivot away from the side S of the container body. The rear support assembly 400 exerts enough torque, by way of the cable and spring components in the two arms 404, 408, to keep the chain 415 taut, as shown in FIG. 5 with the arm assembly 400′ in the mid-travel position. It can be appreciated that the axle A may be following a curved end cap at the opposite ends E of the container body. In that instance, the chain can extend from the cap 410 of the extension arm 408 at a non-colinear, upward, angle.

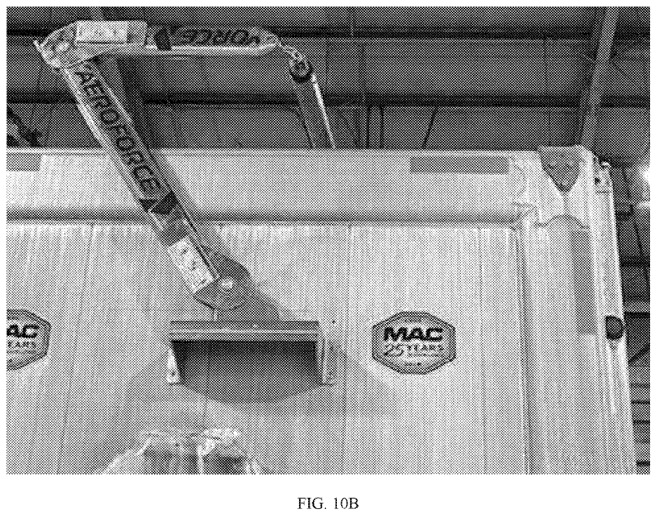

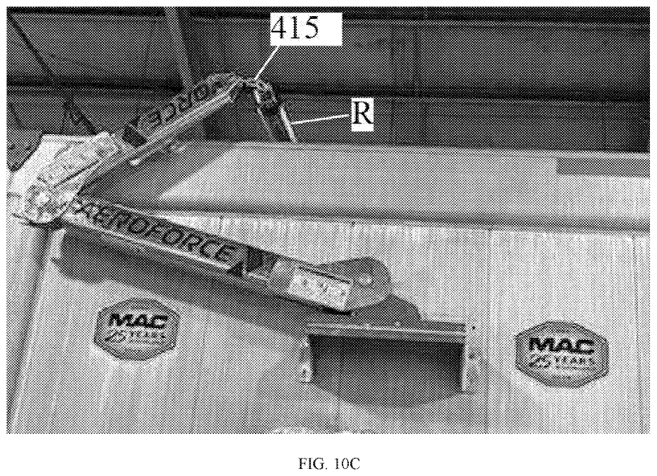

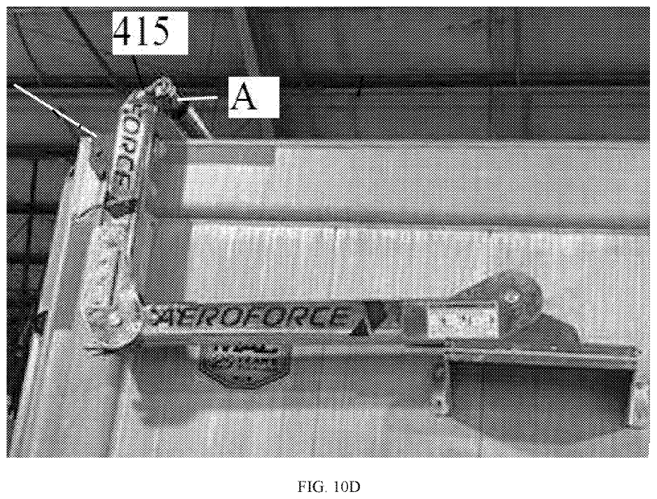

FIGS. 10A-10D depict the position of the rear support assembly 400 as the assembly moves from the retracted position. As the axle A travels toward the opposite side of the container to cover the opening, the angle of the chain relative to the extension arm varies, as illustrated in FIGS. 10A-10D. Thus, when moving from the deployed position to the open position, the chain 415 extends laterally and slightly downwardly, as shown in FIG. 10A, to elevate the axle A above the end cap of the trailer. The chain maintains that orientation as the support assembly 400 sweeps further across the container, as shown in FIG. 10B. When the rear support assembly 400 nears the opposite side of the container, as shown in FIG. 10C, the angle of the chain 415 drops below horizontal and retains that orientation until the arm assembly passes over the side of the container, as shown in FIG. 10D. In the deployed orientation shown in FIG. 5, the chain extends downward to the axle to help pull the axle A and roller R upward into a latch (not shown) that is used to hold the roller against the container body while the trailer is moving.

It can be appreciated that the rear support assembly 400, and particularly the chain 415, holds the end of the roller R above a heaped load in the container as the roller pulls the cover across the top of the container. This is accomplished by a combination of the lower arm 404 and extension arm 408 having a length that allows the distal end 408a of the extension arm to pass above the top of the container as the rear support assembly 400 sweeps across the container, and the short length of the flexible link or chain 415 maintaining the axle A and roller R of the cover system immediately adjacent the end of the extension arm. This close proximity and the torque applied by the springs 111, 113 of the two arms keep the roller, and thus the tarp, elevated about the opening of the trailer, and especially elevated above a heaped load in the container.. The flexible link/chain 415 remains taut throughout the process and lifts the roller R up to keep it clear of the heaped load.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims.

What is claimed is:

1. A cover system for an elongated open-topped container body, comprising:
an elongated cover sized and configured to span a length of the open top of the container and to span the width of the open top of the container in a deployed position, the cover wound on a cylindrical roller spanning the length of the container;
a first arm assembly pivotably mountable at one end of the container body, the arm assembly configured to be coupled to one end of the cylindrical roller and including a drive motor for rotating the roller to wind the cover onto the roller to a retracted position in which the open top is open and to unwind the cover from the roller in a deployed position in which the cover spans the width of the open top;
a second arm assembly mountable at an opposite end of the container body, the second arm assembly including;
an elongated lower arm pivotably mountable at one end thereof to the container body; and
an elongated extension arm, pivotably mounted at a first end to an end of the lower arm opposite said one end and having an opposite second end,
wherein the lower arm and extension arm are sized so that said opposite second end of said extension arm is immediately adjacent the cylindrical roller at all times when the roller moves between the retracted and deployed positions; and
an engagement assembly connecting said opposite second end of said extension arm to the roller of the cover, said engagement assembly including an elongated flexible link, fastened at a first end thereof to said opposite second end of said extension arm and connectable at an opposite second end to said roller.

2. The cover system of claim 1, wherein said engagement assembly includes:
a first cap fixed to said opposite second end of said extension arm;
a second cap;
fasteners for connecting said first end of said flexible link to said first cap and said second end of said flexible link to said second cap; and
a cylindrical hub configured to be fixed to said roller and mounted on said second cap for rotation with the roller about a longitudinal axis of said hub.

3. The cover system of claim 2, wherein:
said cylindrical hub is hollow; and
said engagement assembly includes;
a washer in bearing contact between said second cap and one end of said cylindrical hub;
a cylindrical bushing extending through said hollow cylindrical hub; and
a bolt extending through said cylindrical bushing to engage said second cap,
wherein said cylindrical hub is trapped between said cylindrical bushing and said second cap for rotation with said roller.

4. The cover system of claim 2, wherein:
said flexible link is a chain; and
said fasteners are bolts or hasps configured to pass through a link of the chain at each end of the chain and configure to engage the first and second caps to fasten the corresponding link of the chain.

5. The cover system of claim 1, wherein said flexible link has a length of less than about nine (9) inches between said first and second end thereof.

6. The cover system of claim 5, wherein said flexible link has a length of less than about six (6) inches between said first and second end thereof.

7. The cover system of claim 1, wherein:
said first arm assembly includes a spring arrangement for generating a torque between the container body and said first arm assembly as said first arm assembly pivots relative to said one end; and
said second arm assembly includes a spring arrangement for generating a torque between said second arm assembly and said first arm assembly as said second arm assembly pivots relative to said first arm assembly.

8. A support assembly for supporting one end of a cover system for an open-topped container, the cover system including a flexible cover wound onto a roller and operable to extend the cover over the open top of the container in a deployed position and to retract the cover in a retracted position, the support assembly comprising:
an elongated lower arm pivotably mountable at one end thereof to the container body;
an elongated extension arm, pivotably mounted at a first end to an end of the lower arm opposite said one end and having an opposite second end, wherein the lower arm and extension arm are sized so that said opposite second end of said extension arm is immediately adjacent the roller at all times when the roller moves between the retracted and deployed positions; and
an engagement assembly connecting said opposite second end of said extension arm to the roller of the cover, said engagement assembly including an elongated flexible link, fastened at a first end thereof to said opposite second end of said extension arm and connectable at an opposite second end to the roller.

9. The support assembly of claim 8, wherein said engagement assembly includes:
a first cap fixed to said opposite second end of said extension arm;
a second cap;
fasteners for connecting said first end of said flexible link to said first cap and said second end of said flexible link to said second cap; and
a cylindrical hub configured to be fixed to said roller and mounted on said second cap for rotation with the roller about a longitudinal axis of said hub.

10. The support assembly of claim 9, wherein:
said cylindrical hub is hollow; and
said engagement assembly includes:
a washer in bearing contact between said second cap and one end of said cylindrical hub;
a cylindrical bushing extending through said hollow cylindrical hub; and
a bolt extending through said cylindrical bushing to engage said second cap,
wherein said cylindrical hub is trapped between said cylindrical bushing and said second cap for rotation with said roller.

11. The support assembly of claim 9, wherein:
said flexible link is a chain; and
said fasteners are bolts or hasps configured to pass through a link of the chain at each end of the chain and configure to engage the first and second caps to fasten the corresponding link of the chain.

12. The support assembly of claim 8, wherein said flexible link has a length of less than about nine (9) inches between said first and second end thereof.

13. The support assembly of claim 12, wherein said flexible link has a length of less than about six (6) inches between said first and second end thereof.

14. The cover system of claim 8, wherein:
said first arm assembly includes a spring arrangement for generating a torque between the container body and said first arm assembly as said first arm assembly pivots relative to said one end; and
said second arm assembly includes a spring arrangement for generating a torque between said second arm assembly and said first arm assembly as said second arm assembly pivots relative to said first arm assembly.
